(19) United States
(12) Patent Application Publication
(10) Pub. No.: US 2010/0305946 A1
(43) Pub. Date: Dec. 2, 2010

(54) SPEAKER VERIFICATION-BASED FRAUD SYSTEM FOR COMBINED AUTOMATED RISK SCORE WITH AGENT REVIEW AND ASSOCIATED USER INTERFACE

(75) Inventors: Richard Gutierrez, Mountain View, CA (US); Lisa Marie Guerra, Los Altos, CA (US); Anthony Rajakumar, Fremont, CA (US)

Correspondence Address: HAHN AND MOODLEY, LLP, 3333 Bowers Avenue, Suite 130, Santa Clara, CA, 95054, US

(73) Assignee: VICTRIO, Mountain View, CA (US)

(21) Appl. No.: 12/856,200

(22) Filed: Aug. 13, 2010

Related U.S. Application Data
(63) Continuation-in-part of application No. 11/404,342, filed on Apr. 14, 2006.
(60) Provisional application No. 61/335,677, filed on Jan. 11, 2010.

(51) Int. Cl. G10L 17/00

(52) U.S. Cl. 704/246

(57) ABSTRACT

Disclosed is method for screening an audio for fraud detection, the method comprising: providing a User Interface (UI) control capable of: a) receiving an audio; b) comparing the audio with a list of fraud audios; c) assigning a risk score to the audio based on the comparison with a potentially matching fraud audio of the list of fraud audios; and d) displaying an audio interface on a display screen, wherein the audio interface is capable of playing the audio along with the potentially matching fraud audio, and wherein the display screen further displays metadata for each of the audio and the potentially matching fraud audio thereon, wherein the metadata includes location and incident data of each of the audio and the potentially matching fraud audio.

### RELATED APPLICATIONS

This application is a continuation-in-part of the U.S. patent application Ser. No. 11/404,342 filed Apr. 14, 2006. This application claims the benefit of priority to the U.S. Pat. No. 61/335,677 filed Jan. 11, 2010.

### TECHNICAL FIELD OF THE DISCLOSURE

Embodiments of the disclosure relate to a method and system for screening audios for fraud detection.

### BACKGROUND OF THE DISCLOSURE

Modern enterprises such as merchants, banks, insurance companies, telecommunications companies, and payments companies are susceptible to many forms of fraud, but one form that is particularly pernicious is credit card fraud. With credit card fraud, a fraudster fraudulently uses a credit card or credit card credentials (name, expiration, etc.) of another to enter into a transaction for goods or services with a merchant.

Another form of fraud that is very difficult for merchants, particularly large merchants, to detect, if at all, occurs in the job application process where an applicant has been designated as undesirable in the past—perhaps as a result of having been fired from the employ of the merchant at one location or for failing a criminal background check—fraudulently assumes a different identity and then applies for a job with the same merchant at a different location. In such cases, failure to detect the fraud could result in the rehiring of the fraudster to the detriment of the merchant. If the fraudster has assumed a new identity, background checks based on identity factors such as names or social security numbers become essentially useless. For example consider that case of a large chain store, such as, for example, Walmart. In this case, an employee can be terminated for say theft at one location, but then rehired under a different identity at another location. The employee represents a grave security risk to the company particularly since the employee, being familiar with the company's systems and internal procedures will be able to engage in further immoral activities.

Various fraud detection systems are used to reduce fraud risks associated with candidates. One such system is described in the co-pending application U.S. Ser. No. 11/754,974.

### SUMMARY OF THE DISCLOSURE

In one aspect, the present disclosure provides a method for screening an audio for fraud detection, the method comprising: providing a User Interface (UI) control capable of: a) receiving an audio; b) comparing the audio with a list of fraud audios; c) assigning a risk score to the audio based on the comparison with a potentially matching fraud audio of the list of fraud audios; and d) displaying an audio interface on a display screen, wherein the audio interface is capable of playing the audio along with the potentially matching fraud audio, and wherein the display screen further displays metadata for each of the audio and the potentially matching fraud audio thereon, wherein the metadata includes location and incident data of each of the audio and the potentially matching fraud audio.

In another aspect, the present disclosure provides a system for screening an audio for fraud detection, the system comprising: a User Interface (UI) control comprising: a) a receiver module capable of receiving an audio; b) a comparator module capable of comparing the audio with a list of fraud audios; c) an risk score generator capable of assigning a risk score to the audio based on the comparison with a potentially matching fraud audio of the list of fraud audios; and d) a display screen capable of displaying an audio interface thereon, wherein the audio interface is capable of playing the audio along with the potentially matching fraud audio, and wherein the display screen further displays metadata for each of the audio and the potentially matching fraud audio thereon, wherein the metadata includes location and incident data of each of the audio and the potentially matching fraud audio.

In yet another aspect of the present disclosure, the present disclosure provides computer-implemented methods, computer systems and a computer readable medium containing a computer program product for screening an audio for fraud detection, the computer program product comprising: program code for a User Interface (UI) control comprising: a) program code for receiving an audio; b) program code for comparing the audio with a list of fraud audios; c) program code for assigning a risk score to the audio based on the comparison with a potentially matching fraud audio of the list of fraud audios; and d) program code for displaying an audio interface on a display screen, wherein the audio interface is capable of playing the audio along with the potentially matching fraud audio, and wherein the display screen further displays metadata for each of the audio and the potentially matching fraud audio thereon, wherein the metadata includes location and incident data of each of the audio and the potentially matching fraud audio.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 shows a pictorial representation of a system used for screening an audio for fraud detection, in accordance with an embodiment of the present disclosure;

FIG. 2 shows a high level flowchart of a method for screening an audio for fraud detection, in accordance with an embodiment of the present disclosure;

FIG. 3 shows hardware to implement the method disclosed herein, in accordance with an embodiment of the present disclosure.

The method and system have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the present disclosure relate to a User Interface (UI) control that compares an audio with a list of fraud audios, assigns a risk score to the audio based on the comparison, and displays a visually highlighted representation of the comparison on a display screen. The UI control further provides an audio interface on the display screen. The audio interlace is capable of playing the audio along with a potentially matching fraud audio of the list of fraud audios. In one embodiment, the visually highlighted representation of the comparison, the risk score, and the audio interface may enable an agent to determine whether the audio belongs to a fraudster or not.

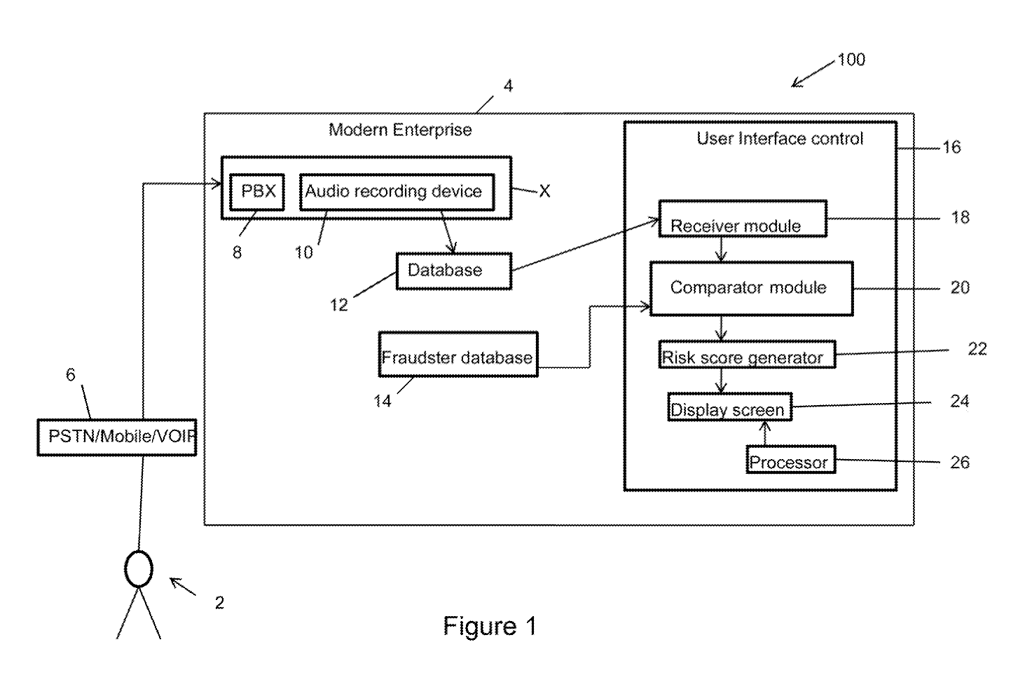

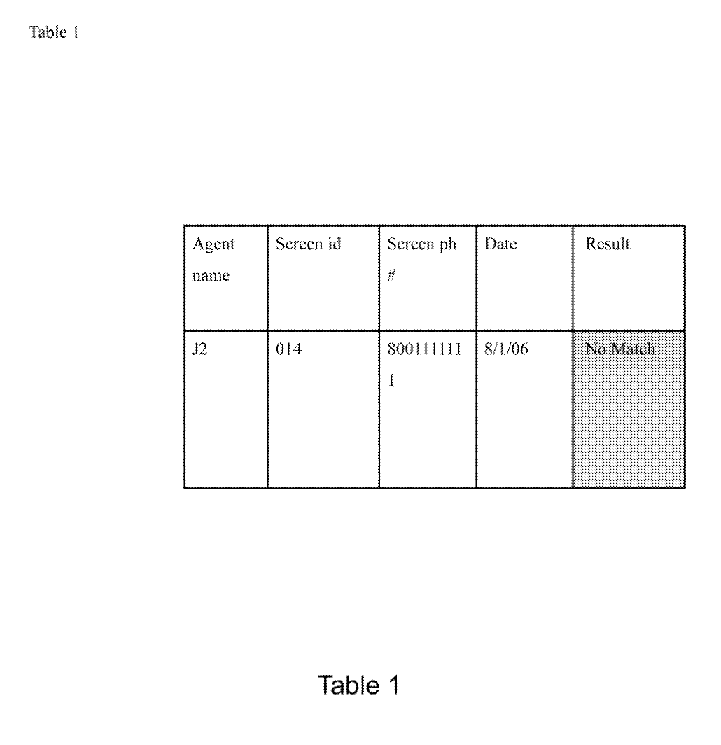

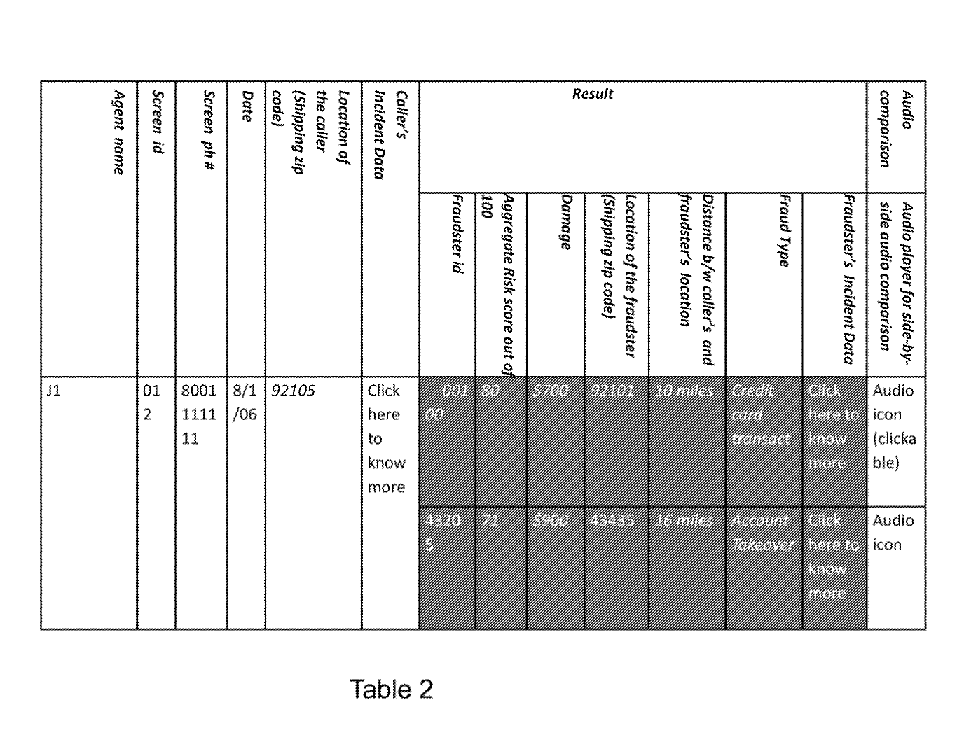

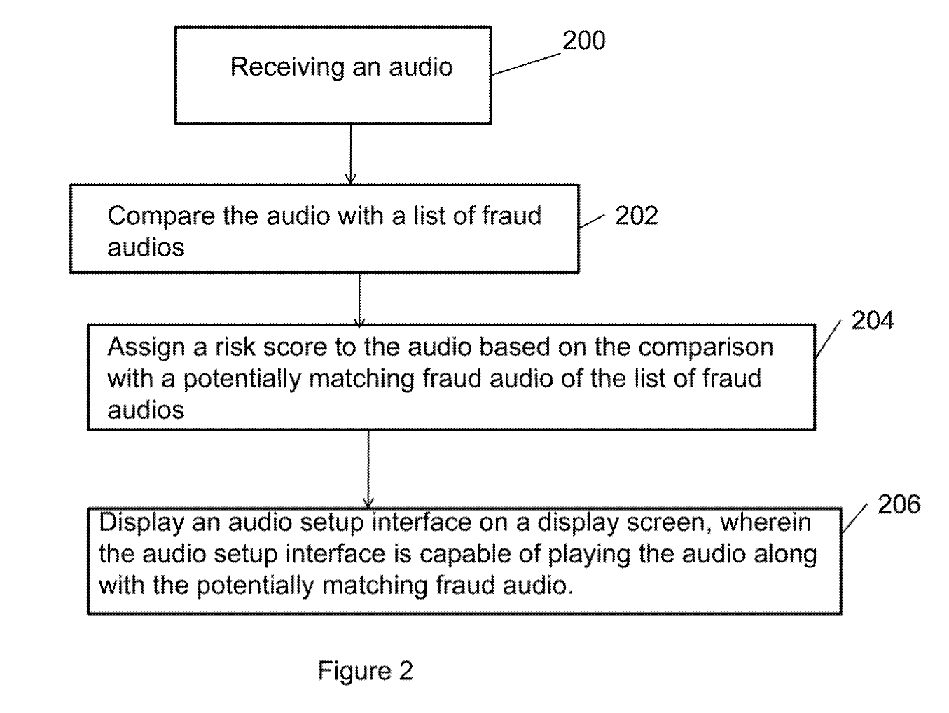

Referring to FIG. 1, a pictorial representation of a system 100 used for screening an audio for fraud detection is shown, in accordance with an embodiment of the present disclosure. In one embodiment, a candidate 2 may call a modern enterprise 4 using a suitable telephone network such as PSTN/Mobile/VOIP 6. The call may be received by a Private Branch Exchange (PBX) 8. The PBX 8 may send the audio to an audio recording device 10 which may record the audio. In one embodiment, a call-center ‘X’ may receive and record the call on behalf of the modern enterprise 4, however, in another embodiment, the modern enterprise 4 may employ an agent (in house or outsourced) or any other third party to receive and record the call.

The audio recording device 10 may be configured to transmit all audios to a database 12 for the purpose of storing. In one embodiment, the modern enterprise 4 may further include a fraudster database 14. The fraudster database 14 includes voice prints of known fraudsters. Essentially, a voice print includes a set of voice characteristics that uniquely identify a person's voice. In one embodiment, each voice print in the fraudster database 14 is assigned a unique identifier (ID), which in accordance with one embodiment may include at least one of a social security number of the fraudster, a name of the fraudster, or credit card credentials linked to the fraudster, date and time of fraud, an amount of fraud, a type of fraud, enterprise impacted, and other incident details.

In the present embodiment, the audios of all candidates may be transmitted to a User Interface (UI) control 16 from the database 12. The UI control 16 may include a receiver module 18, a comparator module 20, a risk score generator 22, a display screen 24, and a processor 26. The receiver module 18 may receive the audio of the candidate 2 from the database 12. The comparator module 20 may compare the audio of the candidate 2 with a list of fraud audios stored in the fraudster database 14. In one embodiment, the comparator module 20 may use a biometric device to compare the audio of the candidate 2 with the list of fraud audios. The biometric device is capable of categorizing similar audios having similar characteristics.

After the audio of the candidate 2 is compared with the list of fraud audios, the risk score generator may assign a risk score to the audio based on the comparison with a potentially matching fraud audio of the list of fraud audios. The risk score is an indication of closeness of the audio with the potentially matching fraud audio. The risk score may be high if the audio matches with the potentially matching fraud audio and would be low if the audio does not match with an audio in the list of fraud audios.

Further, the processor 26 may provide an audio interface on the display screen 24. The audio interface is capable of playing the audio along with the potentially matching fraud audio. The audio interface is further capable of playing selective content of at least one of the audio and the potentially matching fraud audio. In one embodiment, the audio of the candidate 2 being screened is presented side-by-side with the potentially matching fraud audio in the audio interface. Further, candidate's audio and the potentially matching fraud audio snippets are inserted in front of audios of respective samples. Furthermore, the candidate's audio and the potentially matching fraud audio are automatically looped over repeatedly and a fixed duration of each audio can be played one after the other in quick succession in the audio interface. Furthermore, the audio interface provides a feature of playing back specific classes of audio content of the candidate's audio and the potentially matching fraud audio. For example, the agent can do a playback of the candidate and fraudster speaking just ‘numbers’ or just ‘names’ or playback the candidate and fraudster speaking the answer to the same question. Further, the audio interface may provide a single click playback i.e. just a single click is required to hear audio of fraudster and candidate (rather than having to select each one). Further, audio snippets from each of the candidate and the fraudster are alternated back and forth such that the agent can more easily determine if the audio belonged to the same or different people.

Further, the audio interface allows the agent to review top matches and listen to the audios to assess whether the system 100 has accurately matched the candidate's audio with an audio in the fraudster database 14 or not. Therefore, both the system 100 and the agent together determine whether the audio belongs to a fraudster or not.

In one embodiment, the processor 26 further displays top candidate matches on the display screen 24. In the present embodiment, candidates are shown only if their risk scores are above a predefined threshold. This threshold is configurable. Some users may want to see more matches since they are willing to listen to the audio to confirm the results. Further, in one embodiment, the processor 26 generates an indicator on the display screen 24 based on an input from an agent. Specifically, the agent may switch on an indicator on the display screen 24 when the audio belongs to a fraudster. Further, the processor 26 may display information related to the fraud audio on the display screen 24. The information may include an amount of damage, a type of fraud, and reasons the “fraud” audio has been put on a watch-list. In one embodiment, the type of fraud may include at least one of a credit card transaction fraud, an e-commerce fraud, a merchandise fraud, an account takeover fraud, a wire transfer fraud, a new account fraud (identity theft), and a friendly fraud (e.g. child/minor living in same household). Further, the reasons the fraud audio have been put on the watch-list may include the following: account went bad due to non-payment, a transaction was charged back to merchant because a legitimate customer disputed it when they got their bill, the transaction was denied before being allowed to go through based on fraud verification results. Fraud verification results that could have resulted in a denial of the transaction include: the individual did not know answers to a sufficient number of identity verification questions, the individual could not answer questions in a reasonable time frame, the individual had suspicious behavior, etc. The information shown may be used by the agent in conjunction with voice verification results in making a final determination of whether the audio belongs to a fraudster or not.

In one embodiment, a visually highlighted representation of the comparison of the audio with the list of the fraud audios may be displayed on the display screen 24. Specifically, the processor 26 may generate the visually highlighted representation and may display it on the display screen 24. The visually highlighted representation may include information related to the audio as mentioned above. The visually highlighted representation may include at least one of a color highlighting, hatching, shading, shadowing, etc. which may assist an agent to quickly interpret the comparison and determine whether the audio belongs to a fraudster or not. In one embodiment, when the visually highlighted representation is done using colors, varying degrees of matches may be represented using different colors. For example, a red color may symbolize—high likelihood to be a match, a yellow color may symbolize—might be a match, and a green color may symbolize—unlikely to be a match. Alternatively, different colors may be used for the varying degrees of matches.

For example, Table 1 shows a portion of the visually highlighted representation that may be displayed on the display screen 24. Specifically, Table 1 shows that no strong matches with the voiceprints in the fraudster database 14 have been found. Therefore, the result is shown in a light grey shading so that the agent may quickly interpret the comparison in order to determine that the audio does not belong to a fraudster.

Referring now to Table 2, a portion of the visually highlighted representation is shown. In one embodiment, Table 2 includes metadata of the candidate's 2 audio and of the fraud audios. The metadata may assist the agent to come to a conclusion on whether the candidate's 2 audio belongs to a fraudster or not. Specifically, Table 2 contains metadata such as a location of the caller (e.g. shipping zip code where the online ordered goods are to be sent), Incident Data related to the audio, and Distance between the caller's and fraudster's location. In case the caller is a fraudster, the caller's incident data would be parallel to the fraudster incident data. Further, the metadata would make it easy for the agent to interpret the “location” information by telling the agent exactly how far apart the caller and the potentially matching fraudster's locations are. The metadata in conjunction with the risk score and audio are critical in enabling the agent's review process. In the present embodiment, Table 2 shows strong matches of the audio with the voiceprints of the fraudster database 14. Therefore, the result is shown in a dark grey shading so that the agent may quickly interpret the comparison in order to determine that the audio belongs to a fraudster.

Further, in one embodiment, when audio of a candidate matches with a potentially matching fraud audio, the processor 26 may alert the agent via email, SMS, phone, etc to let them know that there is match and display screen 24 has been flagged. The agent may then visit Tables 1 and 2 to view all potential matches that have yet to be reviewed.

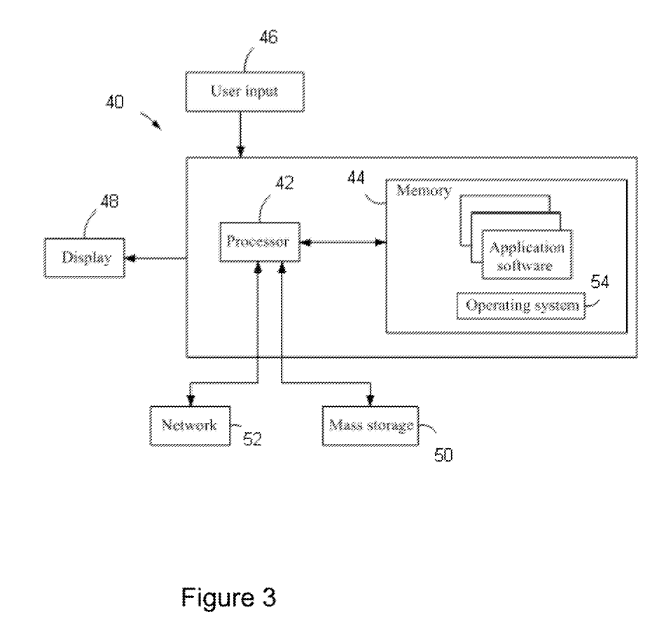

Referring to FIG. 3, a high level flowchart of a method for screening an audio for fraud detection is shown, in accordance with an embodiment of the present disclosure. Specifically, the method provides a User Interface (UI) control. The UI is capable of receiving an audio at 200. At 202, the UI control compares the audio with a list of fraud audios. At 204, UI control assigns a risk score to the audio based on the comparison with a potentially matching fraud audio of the list of fraud audios. At 206, the UI control displays an audio interface on a display screen 24, wherein the audio interface is capable of playing the audio along with the potentially matching fraud audio.

Referring now FIG. 3, hardware 40 to implement the method disclosed herein is shown, in accordance with an embodiment of the present disclosure. The UI control 16, thus far, has been described in terms of their respective functions. By way of example, each of the UI control 16 may be implemented using the hardware 40 of FIG. 3. The hardware 40 typically includes at least one processor 42 coupled to a memory 44. The processor 42 may represent one or more processors (e.g., microprocessors), and the memory 44 may represent random access memory (RAM) devices comprising a main storage of the system 40, as well as any supplemental levels of memory e.g., cache memories, non-volatile or back-up memories (e.g. programmable or flash memories), read-only memories, etc. In addition, the memory 44 may be considered to include memory storage physically located elsewhere in the system 40, e.g. any cache memory in the processor 42, as well as any storage capacity used as a virtual memory, e.g., as stored on a mass storage device 50.

The system 40 also typically receives a number of inputs and outputs for communicating information externally. For interface with a user or operator, the system 40 may include one or more user input devices 46 (e.g.; a keyboard, a mouse, etc.) and a display 48 (e.g., a Liquid Crystal Display (LCD) panel).

For additional storage. the system 40 may also include one or more mass storage devices 50, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 40 may include an interface with one or more networks 52 (e.g., a local area network (LAN), a wide area network (WAN), a wireless network, and/or the Internet among others) to permit the communication of information with other computers coupled to the networks. It should be appreciated that the system 40 typically includes suitable analog and/or digital interfaces between the processor 42 and each of the components 44, 46, 48 and 52 as is well known in the art.

The system 40 operates under the control of an operating system 54, and executes various computer software applications, components, programs, objects, modules, etc. to perform the respective functions of the UI control 16 and server system of the present disclosure. Moreover, various applications, components, programs, objects, etc. may also execute on one or more processors in another computer coupled to the system 40 via a network 52, e.g. in a distributed computing environment, whereby the processing required to implement the functions of a computer program may be allocated to multiple computers over a network.

In general, the routines executed to implement the embodiments of the present disclosure, may be implemented as pan of an operating system or a specific applications component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the present disclosure. Moreover, while the disclosure has been described in the context of fully functioning computers and computer systems, those skilled in the art will appreciate that the various embodiments of the present disclosure are capable of being distributed as a program product in a variety of forms, and that the present disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

I/we claim:

1. A system for screening an audio for fraud detection, the system comprising:
a User Interface (UI) control comprising:
a receiver module capable of receiving an audio;
a comparator module capable of comparing the audio with a list of fraud audios;
an risk score generator capable of assigning a risk score to the audio based on the comparison with a potentially matching fraud audio of the list of fraud audios; and
a display screen capable of displaying an audio interface thereon, wherein the audio interface is capable of playing the audio along with the potentially matching fraud audio, and wherein the display screen further displays metadata for each of the audio and the potentially matching fraud audio thereon, wherein the metadata includes at least one of a location and incident data of each of the audio and the potentially matching fraud audio.

2. The system of claim 1, wherein the UI control further comprises a processor capable of generating a visually highlighted representation of the comparison on the display screen, wherein visually highlighted representation comprises at least one of a color highlighting, hatching, shading, and shadowing, and wherein the visually highlighted representation may assist an agent to quickly interpret the comparison and determine whether the audio belongs to a fraudster.

3. The system of claim 2, wherein the processor further generates an indicator on the display screen based on an input from an agent, the indicator indicating fraudsters.

4. The system of claim 2, wherein the processor further displays information related to the fraud audio on the display screen, wherein the information comprises an amount of damage, a type of fraud, and reasons for putting the fraud audio on a watch-list

5. The system of claim 4, wherein the type of fraud may include at least one of a credit card transaction fraud, an e-commerce fraud, a merchandise fraud, an account takeover fraud, a wire transfer fraud, a new account fraud, and a friendly fraud.

6. The system of claim 4, wherein the audio interface, the metadata, the information related to the audio, and the risk score enable an agent to determine whether the audio belongs to a fraudster.

7. The system of claim 1, wherein the audio interface is further capable of playing selective content of at least one of the audio and the potentially matching fraud audio.

8. A method for screening an audio for fraud detection, the method comprising:
providing a User Interface (UI) control capable of:
receiving an audio;
comparing the audio with a list of fraud audios;
assigning a risk score to the audio based on the comparison with a potentially matching fraud audio of the list of fraud audios; and
displaying an audio interface on a display screen, wherein the audio interface is capable of playing the audio along with the potentially matching fraud audio, and wherein the display screen further displays metadata for each of the audio and the potentially matching fraud audio thereon, wherein the metadata includes at least one of a location and incident data of each of the audio and the potentially matching fraud audio.

9. The method of claim 8, wherein the UI control is further capable of generating a visually highlighted representation of the comparison on the display screen, wherein visually highlighted representation comprises at least one of a color highlighting, hatching, shading, and shadowing, and wherein the visually highlighted representation may assist an agent to quickly interpret the comparison and determine whether the audio belongs to a fraudster.

10. The method of claim 9, wherein the UI control further generates an indicator on the display screen based on an input from an agent, the indicator indicating fraudsters.

11. The method of claim 9, wherein the UI control further displays information related to the fraud audio on the display screen, wherein the information comprises an amount of damage, a type of fraud, and reasons for putting the fraud audio on a watch-list

12. The method of claim 11, wherein the type of fraud may include at least one of a credit card transaction fraud, an e-commerce fraud, a merchandise fraud, an account takeover fraud, a wire transfer fraud, a new account fraud, and a friendly fraud.

13. The method of claim 9, wherein the audio interface, the metadata, the information related to the audio, and the risk score enable an agent to determine whether the audio belongs to a fraudster.

14. The method of claim 8, wherein the audio interface is further capable of playing selective content of at least one of the audio and the potentially matching fraud audio.

15. A computer readable medium containing a computer program product for screening an audio for fraud detection, the computer program product comprising:
program code for a User Interface (UI) control comprising:
program code for receiving an audio;
program code for comparing the audio with a list of fraud audios;
program code for assigning a risk score to the audio based on the comparison with a potentially matching fraud audio of the list of fraud audios; and
program code for displaying an audio interface on a display screen, wherein the audio interface is capable of playing the audio along with the potentially matching fraud audio, and wherein the display screen further displays metadata for each of the audio and the potentially matching fraud audio thereon, wherein the metadata includes at least one of a location and incident data of each of the audio and the potentially matching fraud audio.

16. The computer program product of claim 15, wherein program code for the UI control further comprises program code for generating a visually highlighted representation of the comparison on the display screen, wherein visually highlighted representation comprises at least one of a color highlighting, hatching, shading, and shadowing, and wherein the visually highlighted representation may assist an agent to quickly interpret the comparison and determine whether the audio belongs to a fraudster.

17. The computer program product of claim 16, wherein the program code for UI control further generates an indicator on the display screen based on an input from an agent, the indicator indicating fraudsters.

18. The computer program product of claim 16, wherein the program code for the UI control further displays information related to the fraud audio on the display screen, wherein the information comprises an amount of damage, a type of fraud, and reasons for putting the fraud audio on a watch-list

19. The computer program product of claim 18, wherein the type of fraud may include at least one of a credit card transaction fraud, an e-commerce fraud, a merchandise fraud, an account takeover fraud, a wire transfer fraud, a new account fraud, and a friendly fraud.

20. The computer program product of claim 18, wherein the audio interface, the metadata, the information related to the audio, and the risk score enable an agent to determine whether the audio belongs to a fraudster.

21. The computer program product of claim 15, wherein the audio interface is further capable of playing selective content of at least one of the audio and the potentially matching fraud audio.
